(19) United States
(12) Patent Application Publication
(10) Pub. No.: US 2014/0011066 A1
(43) Pub. Date: Jan. 9, 2014

(54) Apparatus For Supplying Voltage to a Motor Vehicle, In Particular a Storage Module

(71) Applicant: Bayerische Motoren Werke Aktiengesellschaft, Muenchen (DE)

(72) Inventors: Thomas HOEFLER, Groebenzell (DE); Hubertus GOESMANN, Nattheim-Auernheim (DE); Moritz BUSCHER, Muenchen (DE); Gerd WOESLE, Muenchen (DE)

(73) Assignee: Bayerische Motoren Werke Aktiengesellschaft, Muenchen (DE)

(21) Appl. No.: 14/025,122

(22) Filed: Sep. 12, 2013

Related U.S. Application Data
(63) Continuation of application No. PCT/EP2012/000724, filed on Feb. 17, 2012.

(30) Foreign Application Priority Data
Apr. 7, 2011 (DE) 10 2011 006 912.7

(51) Int. Cl. H01G 11/12; H01M 10/50

(52) U.S. Cl. CPC H01G 11/12; H01M 10/5053
USPC 429/99; 361/502

(57) ABSTRACT

Apparatus for supplying voltage to a motor vehicle, in particular a storage module, includes a cell stack with a plurality of storage cells, which each have a storage cell housing and, a front and a rear plate-like element, which are each connected to one another via a left-hand and a right-hand clamping element. The cell stack is clamped in between the plate-like elements by use of the clamping elements. In addition, outer wall insulation is provided which extends in the manner of a ring or sleeve along storage cell outer walls around the cell stack and electrically insulates the cell stack with respect to the plate-like elements and/or the clamping elements.

### CROSS REFERENCE TO RELATED APPLICATIONS

This application is a continuation of PCT International Application No. PCT/EP2012/000724, filed Feb. 17, 2012, which claims priority under 35 U.S.C. §119 from German Patent Application No. DE 10 2011 006 912.7, filed Apr. 7, 2011, the entire disclosures of which are expressly incorporated by reference herein.

### BACKGROUND AND SUMMARY OF THE INVENTION

The present invention relates to an apparatus for supplying voltage to a motor vehicle and, in particular, to a storage module for supplying voltage to a motor vehicle.

Such an apparatus is known from German patent document DE10 2009 035 485 A1. The apparatus comprises a cell stack having a plurality of storage cells, which are each accommodated in a storage cell housing. The cell stack is clamped together under tension by use of a front and a rear plate-type element. The plate-type elements are connected with one another by way of a left and a right tensioning element. Undersides of the storage cell housing are thermally coupled in an electrically insulating manner with a heat-conducting element by way of a floor insulation. By way of the floor insulation, heat generated in the storage cells will be supplied to the heat-conducting element.

Several such “storage modules” can be connected to a “high-voltage accumulator” and can be used as an energy source for an electric drive of a vehicle. In this case, strict demands are to be met with respect to the insulation of the storage module.

It is an object of the invention to create an apparatus, particularly a storage module, for supplying voltage to a motor vehicle, which apparatus has a compact construction and whose cell stack is electrically insulated as well as possible with respect to the components surrounding the cell stack.

This and other objects are achieved according to the invention by providing an apparatus, particularly a storage module, for supplying voltage, particularly to a motor vehicle, comprising a cell stack which consists of a plurality of storage cells. The term “storage cell” should be interpreted extremely broadly. It includes battery or accumulator cells or other “storage devices” in which electric energy can be stored, such as double-layer capacitors. Each of the storage cells has one storage cell housing respectively. The individual storage cells may be interconnected in parallel or in series.

The cell stack is clamped together under tension by a front and a rear plate-type element, which elements are connected with one another by way of a left and a right tensioning element. The plate-type elements may be called “pressure plates”. The tensioning elements may be called “tensioning straps” or “tension rods”. During the mounting of the storage module, the cell stack is compressed. Subsequently, the plate-type elements are welded together with the tensioning elements, for example, by laser welding, so that the cell stack remains durably compressed.

When one or more such storage modules are inserted into a storage housing (battery housing), it is important that the cell stack—or more precisely, the storage cell housings of the cell stack—are electrically insulated well with respect to surrounding components, particularly with respect to the plate-type elements and the tensioning elements. As a function of the tensioning position of the storage modules, an electric insulation, if applicable, should also protect people against accidental contact.

In accordance with the invention, a so-called “exterior wall insulation” extends in a ring- or sleeve-type manner along the exterior walls of the storage cells around the cell stack and electrically insulates the storage cell housing or the cell stack with respect to the plate-type elements and/or the tensioning elements.

As initially mentioned, during the operation of a storage module, considerable amounts of heat may occur in the storage cells. In order to avoid an overheating of the cell stack, the cell stack has to be cooled. A heat-conducting element that, for example, has a plate-type design may be provided for this purpose. The heat-conducting element may be thermally coupled in an electrically insulating manner by way of a “floor insulation” with undersides of the storage cell housings. The floor insulation has a high electrical insulating effect and a high thermal conductivity. By way of the floor insulation, the heat created in the storage cells can easily be removed to the heat-conducting element, which permits a compact construction of the entire arrangement.

In the case of electric voltages of, for example, 450 volts, for reasons of safety, a minimum creepage distance of, for example, 7 mm is required (see DIN EN 60664-1), which could basically result in a relatively large space for the storage module (“creepage” being the shortest path between two conductive parts measured along a surface of the insulation). In order to avoid the above, i.e. in order to achieve a compact construction and sufficiently long air gaps and creepage distances between the storage cell housings of the cell stack and the surrounding components, it may be provided that the exterior-wall insulation and the floor insulation overlap one another at least along a predefined length. As a result of such an overlapping of the two insulations, while the construction is very compact, a sufficiently long creepage distance can be achieved between the storage cell housings of the cell stack, on the one hand, and the plate-type elements and the tensioning elements, on the other hand.

The greater the overlapping of the exterior-wall insulation and the floor insulation, the longer the creep distance of the entire insulation. When the exterior-wall insulation and the floor insulation overlap in the above-described manner,—figuratively speaking—“a bucket of insulating material” is obtained, in which the cell stack is standing.

Preferably, the exterior-wall insulation and the floor insulation (and insulations of the storage cell housings (see below)) mutually overlap along the entire circumference of the cell stack along a predefined minimum length. In this manner, a sufficiently long creep distance can be achieved along the entire circumference of the cell stack.

If the storage module is used as a “high-voltage accumulator” in a motor vehicle, and the operating voltage is in a range of between 300 and 500 volts, it is advantageous for the exterior-wall insulation and the floor insulation to overlap along a length of at least 7 mm.

According to a further development of the invention, the floor insulation is a foil which extends over the entire underside of the cell stack. The floor insulation may be glued to the underside of the storage cell housing as well as to the heat-conducting element. Preferably, an electrically insulating adhesive which has a good thermal conductivity is used.

According to a further development of the invention, each of the storage cell housings of the cell stack can additionally be equipped with a storage cell housing insulation extending in a ring-type or sleeve-type manner around the storage cell housing. The storage cell housing insulation may, for example, be a heat-shrinkable sleeve, which is pushed over the storage cell housing. By heating the heat-shrinkable sleeve, the latter can be shrunk in a closely fitting manner onto the storage cell housing. The storage cell housing insulation may extend from an area of the concerned storage cell housing close to the underside to the top side or into an area close to the top side of the storage cell housing.

In a preferred embodiment of the invention, the exterior-wall insulation and the floor insulation are folded in a labyrinth-type or zig-zag-type manner. In this fashion, a relatively long overlapping distance can very simply and space-savingly be represented, which, in a very narrow space, permits the maintaining of minimum air gaps and minimum creep distances required for safety reasons.

The exterior-wall insulation may be a sprayed insulating component of a plastic material. The exterior-wall insulation may, for example, have a wall thickness which is in the range of between 0.3 and 1.5 mm. Naturally, the thicker the wall thickness of the exterior-wall insulation, the greater the “dielectric strength”. The exterior-wall insulation may also be constructed as a foil. It may be glued onto the cell stack from the outside. The foil may have a smooth construction or may be provided with a three-dimensional structure (for example, a 3d embossing), whereby its insulation effect is further improved.

The floor insulation should be as thin as possible in order to achieve a good heat transfer between the storage cell housing and the heat-conducting element. The thickness of the floor insulation may, for example, be in a range of less than 300 micrometers, particularly in a range of less than 100 micrometers.

According to a further development of the invention, a cooling device is provided by which heat can be withdrawn from the heat-conducting element. The cooling device may be an integral component of the heat-conducting element. As an alternative, it may be provided that the storage module is inserted into a storage housing, a cooling device being arranged between the housing floor of the storage housing and the heat-conducting element, or the cooling device being integrated in the housing floor of the storage housing.

The cooling device may be a combined heating/cooling device, i.e. a device by which the cell stack can be heated or cooled corresponding to the demand depending on the temperature condition of the cell stack.

The storage cell housings may basically have arbitrary shapes. They may, for example, have a cuboid or circular-cylindrical design. Cuboid storage cell housings have the advantage that virtually no dead volumes exist between the individual storage cell housings of the cell stack.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a view of a first embodiment according to the invention; and

FIG. 2 is a view of a second embodiment according to the invention.

### DETAILED DESCRIPTION OF THE DRAWINGS

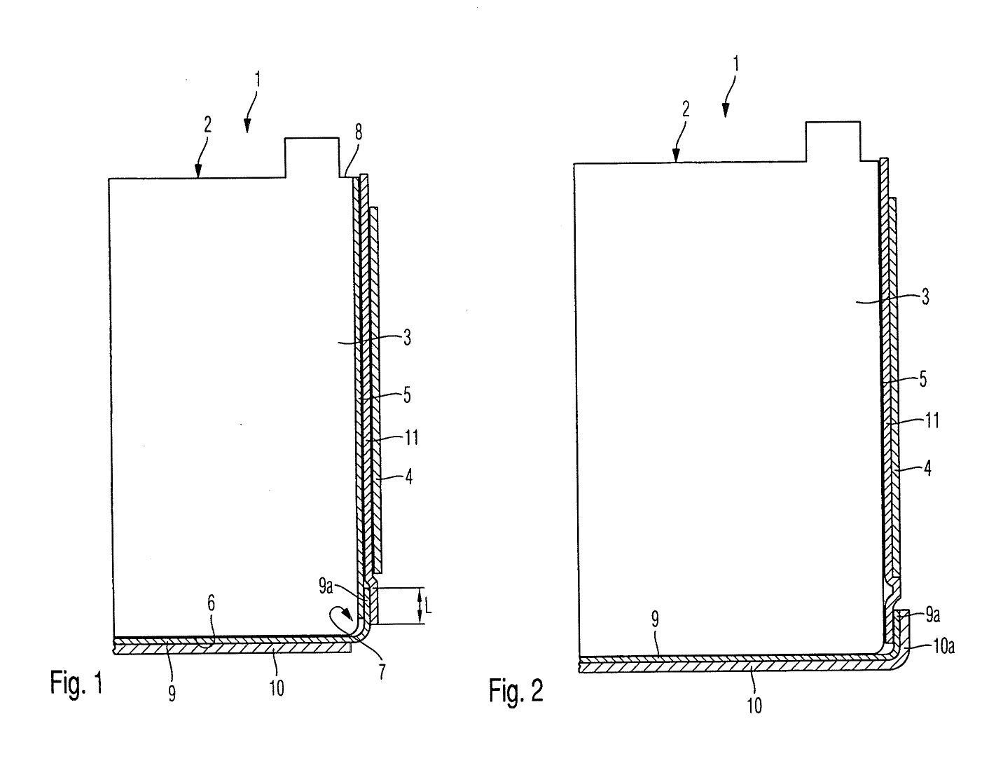

FIG. 1 is a cross-sectional view of a cell stack 1, which consists of a plurality of essentially rectangular or cuboid storage cells arranged one behind the other. Each of the storage cells has a storage cell housing 3. The individual storage cells may have identical designs and be arranged in a direction perpendicular to the plane of projection behind one another in a nested manner.

The cell stack 1 is tensioned in a direction perpendicular to the plane of projection by way of two pressure plates (not shown), specifically a front and a rear pressure plate. The two pressure plates are mutually tensioned by way of a right and a left tensioning element, of which only the right tensioning element (tension rod 4) is visible in FIG. 1. During the operation of such a storage module, considerable pressures may occur as a result of chemical processes taking place in the storage cells, which pressures would lead to a deformation (bulging) of the storage cell housings 3. In order to prevent or limit such deformations of the cell stack, the cell stack is clamped together under tension by way of the pressure plates connected with one another by way of the tensioning elements.

Each of the storage cell housings 3 is equipped with a storage cell housing insulation 5 extending in a ring-type or sleeve-type manner around the storage cell housing 3, which storage cell housing insulation 5 may be formed by a heat-shrinkable sleeve. As illustrated in FIG. 1, the heat-shrinkable sleeve 5 extends from an area 7 close to an underside 6 of the storage cell housing 3 to a top side 8 of the storage cell housing 3. As an alternative to a shrinkable sleeve, the storage cell insulation 5 may also be applied such that it can be compared with a “ribbon” whose ends are glued to one another in an overlapping manner.

An electrically insulating layer 9 is glued onto the undersides 6 of the storage cell housings 3 of the cell arrangement, which layer 9 forms a “floor insulation” of the cell stack 1. The floor insulation 9, in turn, is glued onto the heat conducting plate 10. Heat generated in the storage cells 2 of the cell stack 1 during the operation of the storage module is supplied to the heat conducting plate by way of the floor insulation 9 and is removed from the heat conducting plate by way of a cooling device (not illustrated here in detail).

As illustrated in FIG. 1, the floor insulation 9 in the lower side areas of the cell stack 1 extends upward. The upward-extending area of the floor insulation 9 is marked by the reference number 9a. Solely as a result of the upward-extending of the floor insulation, a lengthening of the creep distance of the storage cell housing 3 is already achieved with respect to the heat-conducting plate 10.

In addition to the upward-extending floor insulation 9, an exterior-wall insulation 11 is provided which extends in a ring-type or sleeve-type manner along the “exterior walls of the cell stack 1” around the entire cell stack 1. The exterior-wall insulation 11 may be formed by an injection-molded part or by an insulation foil. The thickness of the exterior-wall insulation 11 may, for example, be in the range of between 0.3 and 1.5 mm.

As illustrated in FIG. 1, the exterior-wall insulation 11 extends from an area close to the underside 6 to the top side 8. In the embodiment illustrated in FIG. 1, the exterior-wall insulation 11 covers or overlaps the upward-extending area 9a of the floor insulation 9 along a length L. The length L may amount to, for example, 7 mm. As a result of the overlapping of the two insulations 9, 11, a relatively long creep distance of the storage cell housing 3 is achieved with respect to surrounding components, as, for example, the tensioning element 4 or the pressure plates (not shown).

In the embodiment of FIG. 2, the heat-conducting element or the heat-conducting plate 10 has a trough-shaped construction, i.e. it extends upward in an area 10a. The floor insulation 9 is glued onto the entire “top side” of the heat-conducting element 10 and thus also onto the upward-extending section 10a. In contrast to the embodiment of FIG. 1, in the embodiment of FIG. 2, the upward-extending section 9a of the floor insulation overlaps the exterior-wall insulation 11 of the cell stack 1 from the outside.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. An apparatus for supplying voltage to a motor vehicle, comprising:
a cell stack containing a plurality of storage cells, each storage cell having a storage cell housing;
a front plate element and a rear plate element;
a left tensioning element and a right tensioning element, the cell stack being clamped between the front and rear plate elements via the left and right tensioning elements, the front and rear plate elements each being connected with one another via the left and right tensioning elements;
an exterior wall insulation operatively arranged to extend in a ring or sleeve manner along exterior walls of the plurality of storage cells around the cell stack, the exterior wall insulation electrically insulating the cell stack with respect to at least one of the plate elements and the tensioning elements.

2. The apparatus according to claim 1, further comprising:
a floor insulation arranged at undersides of the storage cell housings;
a heat-conducting element thermally coupled via the floor insulation in an electrically insulating manner with the undersides of the storage cell housings, wherein:
by way of the floor insulation, heat generated in the storage cells is supplied to the heat-conducting element, and
the exterior wall insulation and the floor insulation are arranged to overlap one another to a degree sufficient to achieve a minimum creepage distance between the storage cell housings, on the one hand, and the plate elements and the tensioning elements, on the other hand.

3. The apparatus according to claim 2, wherein the floor insulation and the exterior wall insulation overlap one another along an entire circumference of the cell stack, the overlapping area having a predefined length.

4. The apparatus according to claim 3, wherein the predefined length is at least 7 mm.

5. The apparatus according to claim 2, wherein the floor insulation extends over an entire underside of the cell stack.

6. The apparatus according to claim 1, wherein:
each storage cell housing has a storage cell housing insulation extending in a ring or sleeve manner around the storage cell housing, and
the storage cell insulation extends, in each case, from an area of the storage cell housing close to an underside of the storage cell housing into an area of the storage cell housing close to a top side of the storage cell housing.

7. The apparatus according to claim 2, wherein the floor insulation is folded in a labyrinth-type matter with the exterior wall insulation.

8. The apparatus according to claim 1, wherein the exterior wall insulation is a sprayed insulating component of a plastic material.

9. The apparatus according to claim 8, wherein the exterior wall insulation has a wall thickness ranging approximately between 0.3 mm and 1.5 mm.

10. The apparatus according to claim 1, wherein the exterior wall insulation has a wall thickness ranging approximately between 0.3 mm and 1.5 mm.

11. The apparatus according to claim 2, wherein the floor insulation has a thickness of less than 300 micrometers.

12. The apparatus according to claim 2, wherein the floor insulation has a thickness of less than 100 micrometers.

13. The apparatus according to claim 9, wherein the floor insulation has a thickness of less than 100 micrometers.

14. The apparatus according to claim 2, further comprising:
a glued connection of the floor insulation onto the heat-conducting element.

15. The apparatus according to claim 2, further comprising a glued connection of the undersides of the storage cell housings to the floor insulation.

16. The apparatus according to claim 14, further comprising a glued connection of the undersides of the storage cell housings to the floor insulation.

17. The apparatus according to claim 2, further comprising:
a cooler operatively configured to withdraw heat from the heat-conducting element.

18. The apparatus according to claim 2, further comprising:
a storage housing in which the apparatus is arranged;
a cooler operatively arranged either between a housing floor of the storage housing and the heat-conducting element or integrated in the housing floor of the storage housing.

19. The apparatus according to claim 1, wherein the storage cell housings have a cuboid shape.

20. The apparatus according to claim 1, wherein the storage cell housings have a circular-cylindrical shape.
